(19) United States
(12) Patent Application Publication
(10) Pub. No.: US 2003/0028416 A1
(43) Pub. Date: Feb. 6, 2003

(54) Evaluation to technological stragtegies

(75) Inventor: Parasuram V. Pazhayannur, Edina, MN (US)

Correspondence Address: Merchant & Gould, P.C., P.O. Box 2903, Minneapolis, MN, 55402-0903, US

(73) Assignee: Seagate Technology LLC

(21) Appl. No.: 10/061,110

(22) Filed: Feb. 1, 2002

Related U.S. Application Data
(60) Provisional application No. 60/304,962, filed on Jul. 12, 2001.

(51) Int. Cl. G06F 17/60

(52) U.S. Cl. 705/10

(57) ABSTRACT

A process for evaluating a current technological strategy for an organization is disclosed. The process examines the current technological strategy for potential threats and opportunities based on a landmark technology identified during a technology scan. The potential threats and opportunities are evaluated to develop a proposed strategy indicative of the current technological strategy integrated with the landmark technology. A pilot study is performed on the proposed strategy to render a recommendation on whether the proposed strategy should be adopted or rejected by the organization. Based on the recommendation, the proposed strategy may be either implemented or saved for future reference and re-evaluation.

### RELATED APPLICATIONS

This application claims priority of U.S. provisional application Serial No. 60/304,962, filed Jul. 12, 2001.

### TECHNICAL FIELD

The invention relates generally to strategy management. More particularly, the invention relates to evaluating technological strategies of organizations.

### BACKGROUND OF THE INVENTION

Generally, strategic technology management refers to the management of an organization's, i.e., company's, corporation's, etc., strategy for developing and/or using technology. The term “technology” is broadly defined herein to encompass any and all technological, biological, sociological, economical, and medical/psychological areas to which an organization may be associated. With this in mind, a landmark technology may be defined as an emerging technology that, after consideration, may be worthwhile for an organization to pursue. As such, a landmark technology may be either a technology for development by an organization or a technology that would be utilized by an organization in the development of products or services.

Because technologies are continuously changing, volumes have been written and numerous models have been proposed to manage strategies for developing and/or using such technologies. These strategies are hereinafter referred to as technological strategies. A recognized model is Prahalad's notion, which focuses on helping an organization position for the future by analyzing the organization's core competencies. Core competencies may be defined as those areas of technology and development to which each organization is most competent. For example, the core competencies of a computer product manufacturer may be computer monitors, computer casings, computer hard drives, computer peripherals and any other computer related software and or hardware that may be found in or utilized by or with a computer system. In essence, Prahalad's notion argues that the core competencies of an organization should drive the organization's technological strategies.

Although a technological strategy focused on the core competencies of an organization may provide somewhat of a competitive advantage, such strategies may also restrict the organization to venturing into only those technological areas that align with the organization's core competencies. The Van Wck model for strategic technological management, proposes a methodology for identifying landmark technologies using a technology scan irrespective of an organization's core competencies. However, Van Wck's model then suggests evaluating the potential of those landmark technologies identified in a technology scan by comparing each landmark technology to the organization's core competencies to develop a technological strategy having a strategic fit to the organization's core competencies.

Consequently, Van Wck's model effectively develops strategies that are a strategic fit with the current core competencies of an organization. Although technological strategies derived off of one's core competencies may provide a competitive advantage, these strategies necessarily restrict an organization from venturing into those technological areas outside its core competencies. Plainly stated, the strategy formulation step of Van Wck's model defeats the purpose of a technology scan and the foresight obtained from the resulting landmark technologies.

### SUMMARY OF THE INVENTION

Against this backdrop the present invention has been developed. In accordance with an embodiment, the present invention is a method for evaluating a current technological strategy. More particularly, one embodiment of the present invention is a process for evaluating whether a current technological strategy should be modified to conform to a landmark technology. The process first identifies a landmark technology using a technology scan of the relevant technological area. Once a landmark technology is identified, the method examines the current technological strategy for any potential threats and opportunities based on the landmark technology. The process then evaluates the identified potential threats and opportunities to develop a proposed strategy indicative of an integration of the landmark technology into the current technological strategy. The process then determines whether any core competencies required to implement the proposed strategy should be developed internally or externally to the organization if the organization does not currently have the core competencies. Finally, the process renders a recommendation on whether the organization should adopt the proposed strategy. This recommendation therefore takes into account whether the core competencies required to implement the proposed strategy should be developed internally or externally to the organization if, indeed, the organization does not currently have the core competencies. As such, the process is operable to recommend adoption of the proposed strategy by the organization even if the organization does not currently have the required core competencies. Such a recommendation allows an organization to venture away from technological areas that align only with its current core competencies.

The process may present the recommendation to a management system of the organization in a manner operable for the management system to decide whether the organization will adopt or reject the proposed strategy. That is, the decision by the management system may be based on the recommendation, and thus, is made irrespective of whether the organization currently has the core competencies to implement the proposed strategy. Accordingly, the process may include receiving such a decision and thereafter preparing the proposed strategy for implementation if the management system decides that the organization will adopt the proposed strategy. As such, the process may include requesting development of the core competencies by a source internal to the organization or, alternatively, requesting development of the core competencies by a source external to the organization.

Embodiments of the invention may be implemented either manually or as a computer-readable program storage device which tangibly embodies a program of instructions executable by a computer system to evaluate whether a corporate technological strategy should be modified to conform to a landmark technology.

These and various other features as well as advantages, which characterize the present invention, will be apparent from a reading of the following detailed description and a review of the associated drawings.

### BRIEF DESCRIPTION OF THE DRAWINGS

FIG. 1 is a functional diagram of a strategy evaluation system in accordance with an embodiment of the present invention.

FIG. 2 is a flow diagram that illustrates operational characteristics for evaluating a technological strategy in accordance with an embodiment of the present invention.

FIG. 3 is a flow diagram that illustrates operational characteristics shown in FIG. 2 in more detail.

### DETAILED DESCRIPTION

Embodiments of the present invention may be implemented either manually or as a computer-readable program storage device which tangibly embodies a program of instructions executable by a computer system for evaluating a technological strategy, wherein the evaluation may be used in determining whether the strategy should be modified to conform to a landmark technology. As such, the logical operations of the various embodiments of the present invention may be implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations making up the embodiments of the present invention described herein are referred to variously as operations, structural devices, acts or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

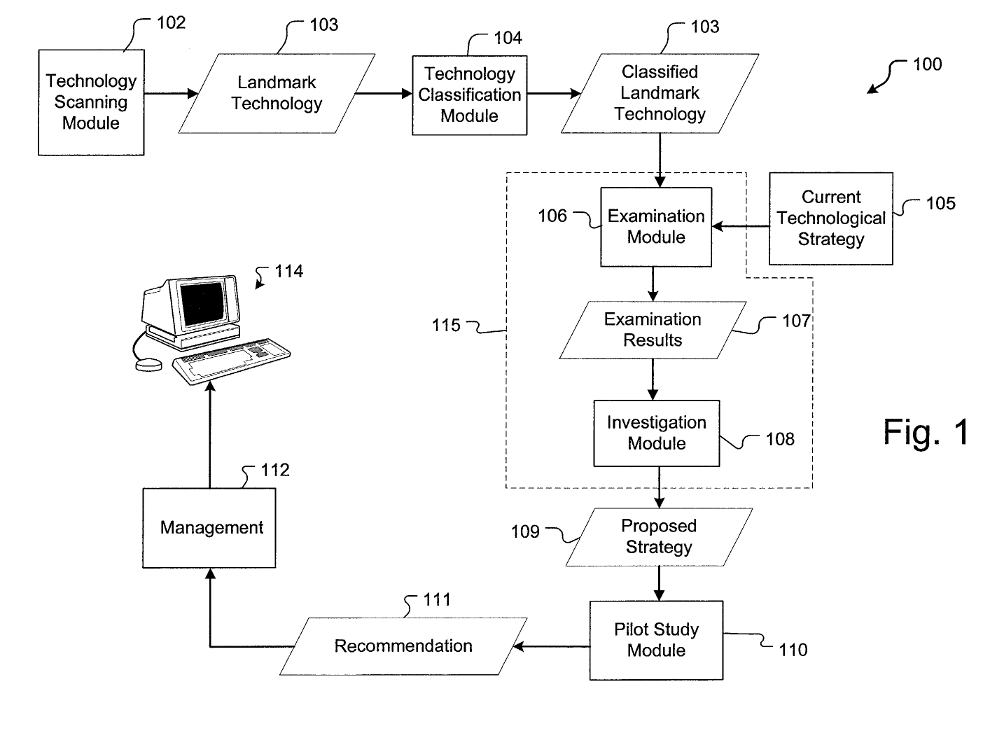

With the computing environment in mind, a conceptual illustration of an embodiment of the present invention is shown in FIG. 1. FIG. 1 shows a strategy evaluation system 100 for evaluating whether a technological strategy should be modified to conform to one or more landmark technologies. In accordance with a preferred embodiment of the present invention, the landmark technologies may be associated with technological areas outside the scope of an organization's current core competencies. The strategy evaluation system 100 may include a technology-scanning module 102, a technology classification module 104, an examination module 106, an investigation module 108 and a pilot study module 110 in accordance with a first embodiment of the present invention. As such, the strategy evaluation system 100 may interact with a management system 112 and an implementation system 114 of an organization as described below. In accordance with second embodiment of the present invention, the strategy evaluation system 100 may include the management system 112 and the implementation system 114.

The technology-scanning module 102 scans a relevant market to identify landmark technologies. The terms “technologies” and “technology” are broadly defined herein to encompass any and all technological, biological, sociological, economical, and medical/psychological areas to which an organization may be associated. The relevant market may be defined broadly or narrowly depending upon the current technological market of the organization utilizing the system 100. For example, a pharmaceuticals manufacturer may define the market as any specific or all biological areas. In a narrow sense, the pharmaceutical manufacturer may define the relevant market as prescription drugs directed to curing a specific disorder. In a broad sense, the pharmaceutical manufacturer may define the relevant market as any drug, both prescription and over-the-counter, designed or manufactured for any purpose.

The technology-scanning module 102 scans the relevant market to identify landmark technologies. The strategy evaluation system 100 is illustrated in FIG. 1 by the technology-scanning module 102 outputting a single landmark technology 103 that is to be used in evaluating whether a current technological strategy 105 should, in fact, be modified to conform with the landmark technology 103. It should be appreciated that the system 100 may be utilized simultaneously to identify multiple landmark technologies and thereafter output the identified landmark technologies to the technology classification module 104. Thus, the single landmark technology 103 is provided for illustration purposes only and preferably is replaced with multiple landmark technologies that may be utilized by the model 100 to evaluate whether the strategy 105 should be modified to conform to each landmark technology.

The landmark technology 103 is output from the technology-scanning module 102 and input to the technology classification module 104. The technology classification module 104 classifies the landmark technology 103 as belonging to one specific technological area. Van Wck's 9-cell model is the most commonly used model for classifying landmark technologies, and in accordance with one embodiment of the present invention, is the model utilized by the technology classification module 104.

The classified landmark technology 103 is input to the examination module 106. A current technological strategy 105 for the organization is also input to the examination module 106. The examination module 106 examines the current technological strategy 105 for potential threats and opportunities based on the landmark technology 103. That is, the examination module 106 determines the impact of the landmark technology 103 on the current technological strategy 105. As such, the examination module 106 labels the landmark technology 103 as either “disruptive” or “enabling” to the current technological strategy 105. Furthermore, the examination module 106 may determine whether the current technological strategy 105 is in alignment with the landmark technology 103. Whether the current technological strategy 105 is in alignment with the landmark technology 103 may depend on the nature of the organization's line of business. That is, the examination module 106 may predict how the organization will respond to the particular landmark technology 103. Finally, the examination module 106 may determine whether the current technological strategy 105 is in need of refinement based on whether the technology is disruptive or enabling to the current technological strategy 105.

The examination results 107 are preferably input to the investigation module 108. The investigation module 108 investigates the examination results 107 to create a proposed technological strategy 109 indicative of an integration of the current technological strategy 105 to the landmark technology 103. In accordance with a preferred embodiment, the investigation module 108 analyzes in detail the potential threats and opportunities to generate the proposed technological strategy 109. To accomplish this, the investigation module 108 may determine the maturity level of the landmark technology 103 and the impact that the landmark technology 103 may have on the organization's current industry. The proposed technological strategy 109 is effectively the current technological strategy 105 modified and conformed to the landmark technology 103. The proposed technological strategy 109 may be included on a strategy table (not shown in FIG. 1) that illustrates the threat and opportunities discovered by the investigation module as well as the examination results 107 generated by the examination module 106. The investigation module 108 and the examination module 106 may be subcomponents of a processing module 115 in accordance with an embodiment of the present invention. As such, the processing module 115 is shown in FIG. 1 using dashed lines surrounding the examination module 106 and the investigation module 108.

The investigation module 108 outputs the proposed strategy 109 to the pilot study module 110. The pilot study module 110 studies the proposed technological strategy 109 to determine the feasibility of actually implementing the proposed strategy 109 based on current financial and operational resources and demand of the organization. In accordance with an embodiment, the pilot study module 110 may determine whether the organization has the core competencies required to execute the proposed strategy 109. If the organization does not currently have the core competencies required to execute the proposed strategy, the pilot study module 110 may determine whether the organization should develop the competencies internally or whether the competencies should be acquired from an outside, or external, source, e.g., a vendor. Plainly stated, the pilot study module 110 reviews the proposed strategy 109 to make a recommendation on whether and in what fashion the organization should adjust its current technological strategy 105 to conform to the landmark technology 103. Such a decision may take into account the amount and allocation of resources that would be needed to effectuate such a modification to the current technological strategy 105. The pilot study module 110 generates a recommendation 111 on whether the organization should or should not modify the current technological strategy 105 to conform with the landmark technology 103. Furthermore, the recommendation 111 may provide a reasoning upon which it relies in rendering the recommendation 111. Such reasoning(s) may be provided in a strategy table, as described above, and may include the examination results 107, as well as the determinations and analyses made by the investigation module 108.

In accordance with one embodiment, the pilot study module 110 may provide the recommendation 111 to a management system 112. The management system 112 may be any form of system operable to make decisions on behalf of the organization. As such, the management system 112 may be a person, such as, without limitation, an organization executive, a group of people, i.e., a plurality of organization executives, or even a computer system under control of one or more persons and programmed to render decisions based on the recommendation 111 provided by the pilot study module 110. For instance, if the management system 112 is a computer system, the recommendation 111 may include some form of recommendation rating designed to give the management system 112 a parameter for use in making a decision on whether to adopt or reject the proposed strategy 109. Therefore, the management system 112, whether human or machine, preferably utilizes the recommendation 111 to determine whether the organization should adopt the proposed strategy 109. In accordance with one embodiment of the present invention, the management system 112 may also use a strategy table (not shown in FIG. 1) for assistance in deciding whether to adopt or reject the proposed strategy 109.

If the management system 112 decides to adopt the proposed strategy 109, the strategy may be prepared for implementation by an implementation module 114. The implementation module 114 may be any type of computing system programmed to prepare the organization for implementation of the proposed strategy 109. If the proposed strategy 109 is not accepted for implementation, the management system 112 may save the recommendation 111 and the proposed strategy 109 for future consideration or reference.

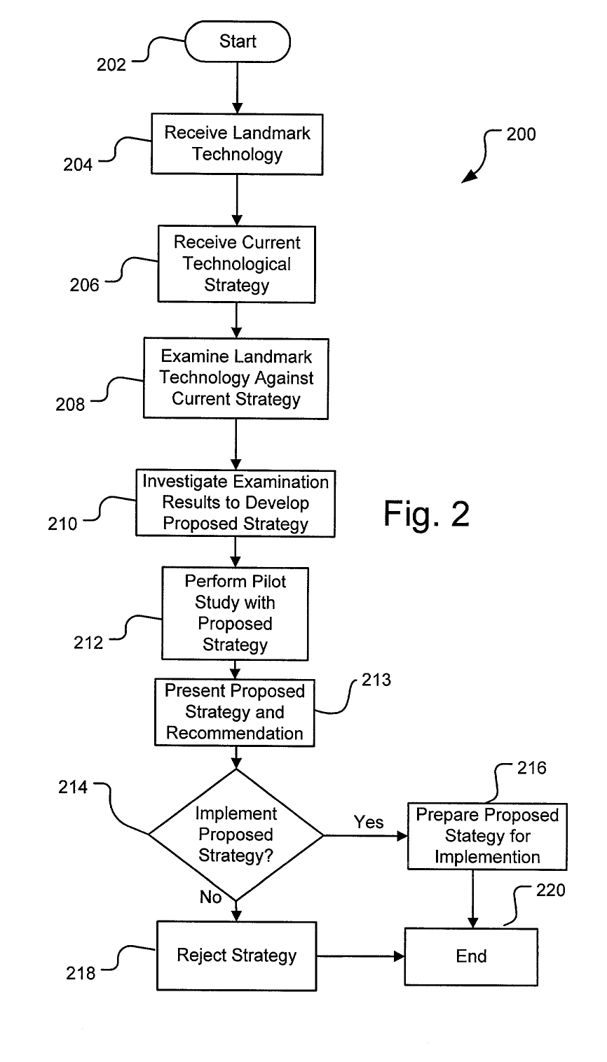

Referring now to FIG. 2, a flow diagram illustrating operational characteristics of an evaluation process 200 for evaluating whether a corporate strategy of an organization should be modified to conform to a landmark technology is shown in accordance with an embodiment of the present invention. As noted above, the evaluation process 200 may be utilized to evaluate a current technological strategy based on multiple landmark technologies. However, for illustrative and claritive purposes, the evaluation process 200 is described below as evaluating whether a current technological strategy should be modified to conform to a single landmark technology. It should be appreciated that the evaluation process 200 may be implemented or performed multiple times, sequentially or simultaneously, to evaluate current technological strategies against one or more landmark technologies.

The evaluation process 200 comprises an operation flow beginning with a start operation 202 and concluding with a terminate operation 220. From the start operation 202, operation flow passes to a landmark technology receive operation 204. The landmark technology receive operation 204 receives a landmark technology that is to be utilized in the evaluation process 200. In accordance with an embodiment of the present invention, the received landmark technology may be a landmark technology identified using a technology scan of a relevant market predefined by the organization. As noted above, the relevant market may be defined broadly or narrowly by the organization. The landmark technology is preferably identified using the technology scan prior to being received by the evaluation process 200. Such a technology scan may be similar to the technology scanning processes described in Van Wck's model, as provided below.

Van Wck's model utilizes Strategic Technology Scanning and Forecasting (STSF) to identify landmark technologies irrespective of an organization's core competencies. STSF may be defined as a systematic process for looking into the future to identify important technologies for the purpose of aiding in policy formation, planning, and decision-making. STSF is a framework that assists corporations in identifying the potential of emerging technologies. STSF then integrates this knowledge into an overall corporate technological strategy. The objective of a strategic technology scan is to obtain technology foresight, a key element for sustained competitive advantage.

After the landmark technology is received by the landmark technology receive operation 204, operation flow passes to a current strategy receive operation 206. The current strategy receive operation 206 receives a current technological strategy of the organization. The current technological strategy, which may be submitted by a management system of the organization, dictates the current goals and direction of the organization with respect to technology development as well as use of specific technologies in the organization's operational needs. Following the current strategy receive operation 206, operation flow passes to an examine operation 208.

The examine operation 208 preferably examines the current technological strategy to identify any potential threats and opportunities based on the landmark technology. The potential threats and opportunities are identified using determinations and conclusions resulting from various inquiries and analyses regarding either co-existence or integration of the landmark technology with the current technological strategy. For example, the examine operation 208 may determine the impact of the landmark technology on the current technological strategy. Accordingly, the examine operation 208 may label the landmark technology as disruptive or enabling to the current technological strategy. Furthermore, the examine operation 208 may determine whether the current technological strategy is in alignment with the landmark technology. The aforementioned determinations and conclusions rendered during examination by the examine operation 208 are provided as illustrations and should not be exhaustive. Indeed, the examine operation 208 may inquire about and thus render various other determinations and conclusions that support the ultimate issue of whether integration of the landmark technology with the current technological strategy may result in a potential threat to or opportunity for the organization. From the examination operation 208, operation flow passes to an investigate operation 210.

The investigate operation 210 investigates potential integration of the landmark technology with the current technological strategy to create a proposed strategy incorporating such integration. The investigate operation 210 creates the proposed strategy by analyzing the potential threats and opportunities identified by the examine operation 208 in detail. The investigate operation 210 may determine whether and/or in what fashion the current technological strategy 105 would need refining should the landmark technology indeed be integrated into the current technological strategy. Such a determination is preferably based on the identified potential threats and opportunities. The investigate operation 210 may also determine the maturity level of the landmark technology and the impact that the landmark technology may have on the organization's current industry. Indeed, the maturity level and impact of the landmark technology is analyzed with the identified potential threats and opportunities. Based on the aforementioned determinations and conclusions, the investigate operation 210 generates a proposed strategy for merging the landmark technology into the current technological strategy. Once the proposed strategy is generated, operation flow passes to pilot study operation 212.

The pilot study operation 212 preferably evaluates the proposed strategy to determine the feasibility of implementation of the proposed strategy by the organization in light of the organization's current financial and operational resources and demands. As such, the pilot study operation 212 determines whether the organization currently has the financial and operational bandwidth required to implement the proposed strategy. Whereas financial bandwidth may refer to amount and allocation of financial resources for operating the organization, operational bandwidth preferably refers to tangible resources, such as, without limitation, employees, core competencies, machinery, services, used in normal and/or extraordinary operating conditions of the organization.

The pilot study operation 212 analyzes the proposed strategy against various aspects associated with both financial and operational bandwidth to ultimately render a recommendation as to whether the proposed strategy should be accepted or rejected by the management system. For example, the pilot study operation 212 preferably evaluates the proposed strategy and then analyzes whether the organization currently has the required core competencies needed to implement the proposed strategy. If the organization does have the core competence required to execute the proposed strategy, the pilot study operation 212 marks the strategy table as such and thereafter takes this fact into account as the pilot study operation 212 generates the recommendation. However, if the organization does not have the core competencies required to implement the proposed strategy, the pilot study operation 212 marks the strategy table as such, takes this fact into account as the pilot study operation 212 generates the recommendation, and further determines whether the core competencies should be developed internally or if the competencies should be acquired from an outside source should the organization elect to adopt the proposed strategy. Based on this determination, the pilot study operation 212 marks the proposed strategy on the strategy table as either being associated with internal development of core competence or external development of core competencies.

After all aspects associated with financial and operational bandwidth are evaluated against the proposed strategy, the pilot study operation 212 recommends whether the organization should adopt or reject the proposed strategy. As noted above, the recommendation may include not only the proposed strategy, but also be accompanied by a strategy table illustrating the determinations and conclusions rendered by the examine operation 208 and the investigate operation 210. As further noted above, the strategy table may include determination and conclusions rendered during the evaluation/analysis by the pilot study operation 212. The strategy table also preferably includes various other proposed strategies based on evaluation of the current technological strategy with other landmark technologies. Indeed, the strategy table may include determinations, conclusions and recommendations associated with evaluation of the same technological strategy against other landmark technologies.

Following the pilot study operation 212, operation flow passes to a present operation 213. The present operation 213 preferably presents the proposed strategy and its associated recommendation to the organization. As noted above, the present operation 213 may present the proposed strategy along with the recommendation to a management system of the organization in accordance with an embodiment of the present invention. As such, the present operation 213 may prepare the proposed strategy, the strategy table and the recommendation for review and interpretation by the management system. The proposed strategy, strategy table and recommendation are then provided by the present operation 213 to the management system in a manner such that the management system may decide whether to adopt or reject the proposed strategy. Plainly stated, the present operation 213 preferably presents the proposed strategy to the management system along with the results, determinations and conclusions of the examine operation 208, the investigate operation 210, and the pilot study operation 212, and a recommendation as to whether the strategy should be adapted or rejected. After the management system decides whether to reject or implement the proposed strategy, operation flow passes to an implement query operation 214.

The implement query operation 214 receives the management system's decision whether to adopt or reject the proposed strategy 109. If the management system has decided to implement the proposed strategy, operation flow passes to a preparation operation 216. The preparation operation 216 prepares the proposed strategy for adoption and implementation by the organization. Following the preparation operation 216, operation flow concludes with a terminate operation 220. If, however, the management system decides to reject the proposed strategy, operation flow passes to a reject operation 218 in accordance with one embodiment of the present invention. The reject operation 218 may mark the proposed strategy as being rejected and thereafter store the proposed strategy in records of a computer database as for subsequent review. The recommendation and associated strategy table may also be stored with the proposed strategy. Following the reject operation 218, operation flow concludes with the terminate operation 220.

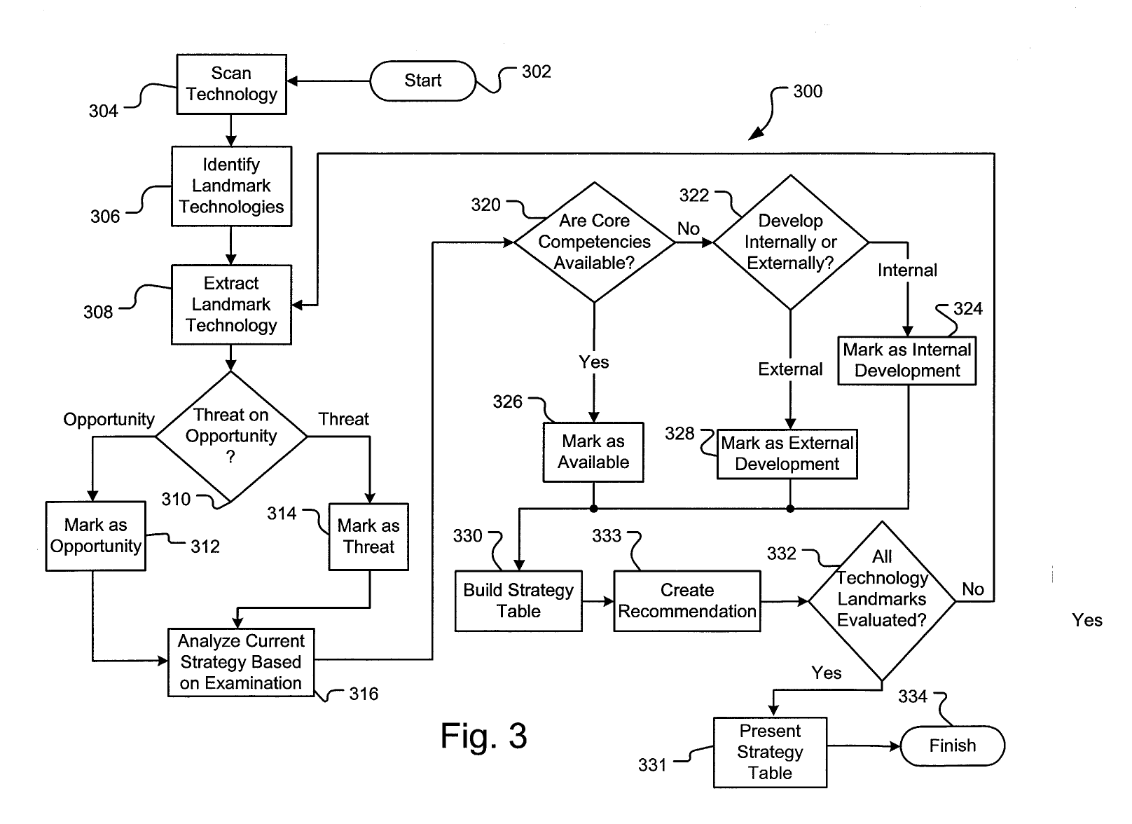

FIG. 3 is an evaluation and presentation process 300 more particularly illustrating operations shown in the evaluation process 200 in accordance with an embodiment of the present invention. The evaluation and presentation process 300 shown in FIG. 3 comprises an operation flow beginning with a start operation 302 and concluding with a terminate operation 334. From the start operation 302, operation flow passes to a scan operation 304. The scan operation 304 scans a relevant market for landmark technologies. As noted above, the relevant market may be broadly or narrowly defined by a management system of the organization. For example, the organization may be a pharmaceutical manufacturer and, thus, the relevant market may be defined by the management system to be any type of drug for manufacture. That is, pharmaceutical manufacturers are typically interested only in technological areas within or somewhat related to biological markets, and not technological areas completely unrelated to their biological areas, such as, for example, manufacturing of transportation vehicles. The scan operation 304 may use the Strategic Technology Scanning and Forecasting (STSF) framework to identify landmark technologies irrespective of an organization's core competencies.

From the scan operation 304, operation flow passes to an identify operation 306. The identify operation 306 identifies those technologies within the technology scan that are considered landmark technologies. A landmark technology for one company may be an irrelevant technology for another company. Plainly stated, the notion of landmark technologies is relative and specific to each company, or organization, conducting the technology scan. Once the landmark technologies are identified, operation flow passes to an extract operation 308. The extract operation 308 extracts a single landmark technology to be evaluated by the evaluation and presentation process 300. The selected landmark technology will then be used by the evaluation and presentation process 300 to determine whether a current technological strategy should be modified to conform to the extracted landmark technology. Continuing with the operation flow, the extracted landmark technology is evaluated by a first query operation 310.

The first query operation 310 determines whether the landmark technology should be classified as a threat or an opportunity to the organization's current technological strategy. If the first query operation 310 determines that the landmark technology poses a threat to the current technological strategy, operation flow passes to a mark threat operation 314. The mark threat operation 314 labels the landmark technology as a threat to the current technological strategy. In contrast, if the first query operation 310 determines that the landmark technology is actually an opportunity, and not a threat, to the current technological strategy, operation flow passes to a mark opportunity operation 312. The mark opportunity operation 312 labels the landmark technology as an opportunity to the current technological strategy.

Illustrating an example of mark operations 312 and 314, the organization may be a pharmaceutical manufacturer specializing in design and development of prescription drugs directed to curing respiratory diseases. As such, the following identified landmark technologies may be analyzed against the pharmaceutical manufacturer's technological strategy: gene therapy, genomics, nanatechnology, slow drug delivery and Bio-MEMS. Each of these five biological technologies are well known, and thus, not described in detail herein. Although only five technologies are illustrated in this example, the identify operation 306 may identify any number of landmark technologies. Furthermore, the organization may be any type of organization, and thus, the relevant market to which the scan is applied may be any type of market area. Plainly stated, the relevant market and identified technologies listed above are not exhaustive, and thus, should not be construed to limit the scope of the present invention.

As briefly noted above, the mark operations 312 and 314 label the landmark technology as either an opportunity or a threat, respectively, by categorizing the landmark technology against the current technological strategy. For example, slow drug delivery may serve as an opportunity to the pharmaceutical manufacturer's current technological strategy because slow drug delivery extends the manufacturer's potential for development of potential respiratory-curing drugs. In contrast, gene therapy and genomics technologies may pose a threat to the pharmaceutical manufacturer's current technological strategy because these technologies may compete with drugs used in curing respiratory diseases. Bio-MEMS technology may be labeled as an opportunity because it is not associated with curing of respiratory diseases, but provides a new means for capital while having no adverse or competitive affects on the respiratory-curing industry. From the mark opportunity operation 312 and mark threat operation 314, operations flow passes to an analysis operation 316.

The analysis operation 316 evaluates the extracted landmark technology 103 based on whether the landmark technology is labeled as a threat or an opportunity. Along with evaluation in detail of whether the landmark technology poses a threat or opportunity to the current technological strategy, the analysis operation 316 addresses three basic inquiries. First, the analysis operation 316 categorizes the landmark technologies as enabling or disruptive. In accordance with an embodiment, the analysis operation 316 may use the determination of whether the technologies are threats or opportunities in assistance with categorizing the landmark technologies as either disruptive or enabling. Second, the analysis operation 316 determines the maturity level of the landmark technology. Third, the analysis operation 316 determines what impact the landmark technology may have on the current technological strategy if the strategy and the technology are indeed integrated. As such, the analysis operation 316 may compile and build an analysis table for each technological strategy that categorizes whether the landmark technologies are disruptive or enabling to the current technological strategy, the maturity level of each landmark technology and the impact that each technology may have on the current technological strategy. Such a table is shown below as Table 1.

TABLE 1

| | Examples of Landmark Technologies | | | | |
|---|---|---|---|---|---|
| PHARMACEUTICAL | | | | Slow drug | |
| COMPANY | Gene Therapy | Genomics | Nanatechnology | delivery | Bio-MEMS |
| Relation to Current | DISRUPTIVE | DISRUPTIVE | N/A | ENABLING | New |
| technological strategy | | | | | Opportunity |
| Maturity | LOW | LOW | LOW | HIGH | LOW |
| Impact on Current | High | Low | Low | High | High |
| technological strategy | | | | | |

Porter's model may be used as a framework for the analysis of whether the landmark technology is disruptive or enabling. In addition, Porter's model may be used to analyze the competitiveness of a potential future industry or business model based on the current knowledge of each landmark technology. Porter's model is widely known, and thus, the details of the analysis for determining whether a technology is enabling or disruptive are not provided in detail.

Table 1 illustrates classification of the landmark technologies as either enabling or destructive. For this illustration, the five exemplary landmark technologies used to illustrate the mark operations 312 and 314 are provided above in Table 1. As noted above, the gene therapy and genomics technological areas are labeled as a threat to the current technological strategy. Indeed, upon further evaluation by the analysis operation 316, the gene therapy and genomics technologies are labeled as disruptive technologies both having a low maturity level. However, the impact of genomics technology on the current technological strategy is low, and therefore, this technology does not pose an “immediate” threat to the current technological strategy. As such, with respect to pharmaceutical manufacturers specializing in design and development of drugs for curing respiratory diseases, it does not make sense to invest in a genomics technology at this point in time. Because this technology is listed as threatening and disruptive, but low impact, the analysis operation 316 may place these technologies in a “watch” category such that the technologies and/or strategy may be updated at a later time.

The situation with slow drug delivery technology is different. Slow drug delivery technology, unlike gene therapy and genomics technologies, is marked as an opportunity and is an enabling technology to the existing respiratory-curing technology of the pharmaceutical manufacturer. Thus, this technology provides a new means for curing respiratory diseases, and therefore, a new means for capital for a pharmaceutical manufacturer specializing in such. The impact on the current technological strategy, which, as noted above, relates to manufacture of respiratory curing drugs, is high. Therefore, if the pharmaceutical manufacturer in this example does not migrate to a slow drug deliver technology, it will be at a disadvantage with respect to its competitors.

The same may be true of the Bio-MEMs technology. The Bio-MEMs technology offers significant opportunities while at the same time having low entry barriers. As such, the Bio-MEMs market may be an ideal technology for pharmaceutical manufacturers to enter due to the manufacturers' access to virtually unlimited biological resources. Thus, the Bio-MEMs would be a good market to enter despite most pharmaceutical manufacturers not having the required core competencies to enter the Bio-MEMs technology market. Therefore, the Bio-MEMs market is a good example of one distinction between the evaluation process of the present invention and the Porter, Prahalad, and Van Wck models previously described above. Whereas the Prahalad and Van Wck models ultimately wouldn't advise entering a market where the organization in question does not have the required core competencies, e.g., the Bio-MEMs market for pharmaceutical manufacturers, the evaluation process 200 of the present invention, more particularly illustrated as an evaluation and presentation process 300 in accordance with a more specific embodiment, identifies such a market as one that would be beneficial for the organization to enter.

The analysis operation 316 generates a proposed strategy for integrating each landmark technology with the current technological strategy by evaluating in detail the identified threats and opportunities in combination with the three basic inquiries listed above. From the analysis operation 316, operation flow passes to a second query operation 320.

The second query operation 320 determines whether the organization currently has the core competencies required to implement the proposed strategy. If the organization does have the core competencies available, operation flow passes to a mark available operation 326. The mark available operation 326 labels the technology as one in which the organization does indeed have the core competencies available to implement the proposed strategy. From the mark available operation 326, operation flow passes to a build table operation 330. The build table operation 330 builds, or continues building, i.e., on subsequent operation flow passes, a strategy table illustrating the determinations and conclusions rendered by operations in the evaluation and presentation process 300 for each landmark technology. That is, the strategy table preferably combines data extracted from either the mark opportunity operation 312 or the mark threat operation 314 and the analysis operation 316 with identification on whether the organization has the core competencies available for the proposed strategy, as labeled by mark available operation 326.

If the second query operation 320 determines that the organization does not currently have the core competencies available to implement the proposed strategy, operation flow passes to a third query operation 322. The third query operation 322 determines whether the core competencies should be developed internal to the organization or by an external source. The parameters used in determining whether the core competencies should be developed internally to the organization or by an external source are preferably defined by the management system of the organization such that the third query operation 322 may readily ascertain the answer to this inquiry without any additional user input from the management system. If the third query operation 322 determines that the core competencies should be developed by a source external to the organization, operation flow passes to an external mark operation 328. The external mark operation 328 labels the landmark technology as being associated with core competencies to be developed outside of the organization. From the external mark operation 328, operation flow passes to the build table operation 330. The build table operation 330 builds, or continues building, i.e., on subsequent operation flow passes, a strategy table illustrating the determinations and conclusions rendered by operations in the evaluation and presentation process 300 for each landmark technology. That is, the strategy table preferably combines data extracted from either the mark opportunity operation 312 or the mark threat operation 314 and the analysis operation 316 with identification that the core competencies should be developed by an external source, as marked by external mark operation 328.

If the third query operation 322 determines that the core competencies would be more effectively developed by a source internal to the organization, operation flow passes to an internal mark operation 324. The internal mark operation 324 labels the landmark technology as one being associated with core competencies that would be more effectively developed by a source internal to the organization. From the internal mark operation 324, operation flow passes to the build table operation 330. The build table operation 330 builds, or continues building, i.e., on subsequent operation flow passes, a strategy table illustrating the determinations and conclusions rendered by operations in the evaluation and presentation process 300 for each landmark technology. That is, the strategy table preferably combines data extracted from either the mark opportunity operation 312 or the mark threat operation 314 and the analysis operation 316 with identification that the core competencies should be developed by the organization, as marked by internal mark operation 324.

An example of a strategy table is shown below in Table 2 in accordance with an embodiment of the present invention. It should be appreciated that the headings and sub-headings of Table 2 are not exhaustive, and thus, Table 2 is only illustrative of one specific embodiment of the present invention. Indeed, the evaluation and presentation process 300 may not even create a strategy table but rather a proposed strategy and associated recommendation in accordance with one embodiment of the present invention. Furthermore, if the process 300, indeed, creates a strategy table, the table may include any type of determination and/or conclusion that may be rendered or used in evaluating whether a technological strategy should be modified to conform to an identified landmark technology.

TABLE 2

| | Examples of Landmark Technologies | | | | |
|---|---|---|---|---|---|
| PHARMACEUTICAL | | | | Slow drug | |
| COMPANY | Gene Therapy | Genomics | Nanatechnology | delivery | Bio-MEMS |
| Relation to Current | DISRUPTIVE | DISRUPTIVE | N/A | ENABLING | New |
| technological strategy | | | | | Opportunity |
| Maturity | Low | LOW | LOW | High | LOW |
| Impact on Current | High | Low | Low | High | High |
| technological strategy | | | | | |
| Does Organization | Yes | No (Internal) | No (External) | No | No |
| have Core | | | | (Internal) | (External) |
| Competencies? (If no, | | | | | |
| should core | | | | | |
| competencies be | | | | | |
| developed internally | | | | | |
| or externally?) | | | | | |
| Recommend | Yes | No | No | Yes | Yes |
| Implementation? | | | | | |

Strategy tables provide the management system with an organized summary of the results of the evaluation of each landmark technology identified by the identify operation 306. In particular, the strategy table provides an evaluation of an integration of the current technological strategy with one or more emerging landmark technologies independent of the organization's core competencies. From the build strategy table operation 330, operation flow passes to a fourth query operation 332. The fourth query operation 332 determines whether all the identified landmark technologies have been evaluated with the current technological strategy. If each identified landmark technology has not been evaluated, operation flow passes back to the extract operation 308 and a next landmark technology is extracted and evaluated with the current technological strategy using the evaluation and presentation process 300. If, however, all landmark technologies have been evaluated with the current technological strategy, the strategy table is therefore complete and operation flow passes to a recommendation operation 333.

The recommendation operation 333 provides a recommendation on whether the organization should, indeed, modify the current technological strategy to conform to each extracted landmark technology. The recommendation utilizes the determinations and conclusions of the mark operations 312 and 314, the analysis operation 316 and the mark operations 324, 326, and 328 in generating the recommendation. As such, the recommendation operation 333 may utilize a strategy table, such as the strategy table shown in Table 2, to formulate the recommendation. The recommendation for each landmark technology is preferably added to the strategy table. From the recommendation operation 333, operation flow passes to a present operation 331.

The present operation 331 presents the strategy table, preferably inclusive of the recommendation for each landmark technology, to the management system so that the management system may make a determination on whether each proposed strategy should be adopted or rejected. The strategy table, which necessarily includes the proposed strategies for each landmark technology analyzed against the organization's current technological strategy, allows the management to evaluate and compare proposed strategies for each identified landmark technology. For example, referring to the strategy table of Table 2, the headings of the columns are indicative of each evaluated landmark technology. Following the present operation, operation flow concludes with a termination operation 334.

In summary, the present invention may be viewed as a method (such as in operation 200) for evaluating a technological strategy (such as 105) for an organization. The method preferably includes a step of identifying (such as in operation 306) a landmark technology (such as 103) and thereafter a step of examining (such as in operation 208) the current technological strategy to identify any potential threats and opportunities based on the landmark technology. In accordance with a specific embodiment, the identifying step may include a step of scanning (such as in operation 304) a relevant technological area to identify the landmark technology. The method also preferably includes a step of evaluating (such as in operation 210) the identified potential threats and opportunities to develop a proposed strategy (such as 109) indicative of an integration of the landmark technology with the current technological strategy and a step of determining (such as in operation 212) whether any core competencies required to implement the proposed strategy should be developed internally or externally to the organization if the organization does not currently have the core competencies required to implement the proposed strategy. The method may also include a step of rendering (such as in operation 212) a recommendation on whether the organization should adopt the proposed strategy.

In accordance with an embodiment, the method may further include a step of receiving (such as in operation 214) a determination by the organization on whether to adopt or reject the proposed strategy. If the organization elects to adopt the proposed strategy, the method preferably include a step of preparing (such as in operation 216) the proposed strategy for implementation by the organization. As such, the preparing step may include requesting development of the core competencies by a source internal to the organization. Alternatively, the preparing step may include requesting development of the core competencies by a source external to the organization. In accordance with an alternative embodiment, the method may comprise preparing the organization for implementation of the proposed strategy without receiving a decision to adopt from the organization if the recommendation recommends adopting the proposed strategy. The method may further include saving the proposed strategy for future reference and re-evaluation by the organization if the organization elects to reject the proposed strategy.

In accordance with one embodiment, the presenting step may comprise providing the recommendation to a management system (such as 112) of the organization. The management system may comprise a computing system programmed for evaluation of whether the proposed strategy should be adopted by the organization based on the recommendation. In accordance with an embodiment of the present invention, the identifying step, the examining step, the evaluating step, the determining step and the rendering step of the method may be performed manually.

In accordance with another embodiment, the present invention may be viewed as a computer-readable program storage device which tangibly embodies a program of instructions executable by a computer system to evaluate a current technological strategy (such as 105) for an organization. Therefore, each of the above-described operations and implementations may be performed by a program storage device readable by a computer system tangibly embodying a program of instructions executable by the computer system to perform a method for evaluating a current technological strategy for an organization.

In accordance with yet another embodiment, the present invention may be viewed as a system (such as 100) for recommending whether a current technological strategy (such as 105) for an organization should be modified to conform to a landmark technology (such as 103). The system preferably includes a processing module (such as 115) examining the current technological strategy to identify any potential threats and opportunities based on the landmark technology and evaluating the identified potential threats and opportunities to develop a proposed strategy (such as 109) indicative of an integration of the landmark technology with the current technological strategy. The system also preferably includes means (such as 110) for determining whether any core competencies required to implement the proposed strategy should be developed internally or externally to the organization if the organization does not currently have the core competencies.

In accordance with one embodiment, the system may further include a means (such as 103) for scanning a relevant technological area to identify the landmark technology. In accordance with a second embodiment, the system may include a means (such as 110) for rendering a recommendation (such as 111) on whether the organization should adopt the proposed strategy. As such, the system may include a means (such as 114) for preparing the proposed strategy for implementation by the organization if the recommendation recommends adopting the proposed strategy. The preparing means may request development of the core competencies by a source internal to the organization or a source external to the organization. The system may alternatively present the recommendation to the organization such that the organization may adopt or reject the proposed strategy. If the organization adopts the proposed strategy, the system then prepares the proposed strategy for implementation using the preparing means.

It will be clear that the present invention is well adapted to attain the ends and advantages mentioned, as well as those inherent therein. While a presently preferred embodiment has been described for purposes of this disclosure, various changes and modifications may be made which are well within the scope of the present invention. Indeed, numerous changes may be made which will readily suggest themselves to those skilled in the art and which are encompassed in the spirit of the invention disclosed and as defined in the appended claims.

What is claimed is:

1. A method for evaluating a current technological strategy for an organization, the method comprising steps of:
(a) identifying a landmark technology;
(b) examining the current technological strategy to identify any potential threats and opportunities based on the landmark technology;
(c) evaluating the identified potential threats and opportunities to develop a proposed strategy indicative of an integration of the landmark technology with the current technological strategy; and
(d) determining whether any core competencies required to implement the proposed strategy should be developed internally or externally to the organization if the organization does not currently have the core competencies.

2. The method of claim 1, further comprising a step of:
(e) rendering a recommendation on whether the organization should adopt the proposed strategy.

3. The method of claim 2, further comprising steps of:
(f) receiving a determination by the organization on whether to adopt or reject the proposed strategy; and
(g) if the organization elects to adopt the proposed strategy, preparing the proposed strategy for implementation by the organization.

4. The method of claim 3, wherein the preparing step (g) comprises a step of:
requesting development of the core competencies by a source internal to the organization.

5. The method of claim 3, wherein the preparing step (g) comprises a step of:
requesting development of the core competencies by a source external to the organization.

6. The method of claim 3, further comprising steps of:
(h) if the organization elects to reject the proposed strategy, saving the proposed strategy for future reference and re-evaluation by the organization.

7. The method of claim 2, wherein the rendering step (e) comprises a step of:
providing the recommendation to a management system of the organization.

8. The method of claim 7, wherein the management system comprises a computing system programmed for evaluation of whether the proposed strategy should be adopted by the organization based on the recommendation.

9. The method of claim 2, wherein the identifying step (a), the examining step (b), the evaluating step (c), the determining step (d) and the rendering step (e) are performed manually.

10. The method of claim 2, further comprising a step of:
(f) if the recommendation recommends adopting the proposed strategy, preparing the organization for implementation of the proposed strategy.

11. The method of claim 10, wherein the preparing step (f) comprises a step of:
requesting development of the core competencies by a source internal to the organization.

12. The method of claim 10, wherein the preparing step (f) comprises a step of:
requesting development of the core competencies by a source external to the organization.

13. The method of claim 2, further comprising:
(f) if the recommendation recommends rejecting the proposed strategy, saving the proposed strategy in a database for future reference and re-evaluation by the organization.

14. The method of claim 1, wherein the identifying step (a) comprises a step of:
scanning a relevant technological area to identify the landmark technology.

15. A program storage device readable by a computer system tangibly embodying a program of instructions executable by the computer system to perform a method for evaluating a current technological strategy for an organization, the method comprising steps of:
(a) identifying a landmark technology;
(b) examining the current technological strategy to identify any potential threats and opportunities based on the landmark technology;
(c) evaluating the identified potential threats and opportunities to develop a proposed strategy indicative of an integration of the landmark technology with the current technological strategy; and
(d) determining whether any core competencies required to implement the proposed strategy should be developed internally or externally to the organization if the organization does not currently have the core competencies.

16. A program storage device as defined in claim 15, wherein the method further comprises a step of:
(e) rendering a recommendation on whether the organization should adopt the proposed strategy.

17. A program storage device as defined in claim 16, wherein the method further comprises steps of:
(f) receiving a determination by the organization on whether to adopt or reject the proposed strategy; and
(g) if the organization elects to adopt the proposed strategy, preparing the proposed strategy for implementation by the organization.

18. A program storage device as defined in claim 17, wherein the preparing step (g) comprises a step of:
requesting development of the core competencies by a source internal to the organization.

19. A program storage device as defined in claim 17, wherein the preparing step (g) comprises a step of:
requesting development of the core competencies by a source external to the organization.

20. A program storage device as defined in claim 16, wherein the method further comprises a step of:
(f) if the recommendation recommends adopting the proposed strategy, preparing the organization for implementation of the proposed strategy.

21. A program storage device as defined in claim 20, wherein the preparing step (f) comprises a step of:
requesting development of the core competencies by a source internal to the organization.

22. A program storage device as defined in claim 20, wherein the preparing step (f) comprises a step of:
requesting development of the core competencies by a source external to the organization.

23. A program storage device as defined in claim 15, wherein the identifying step (a) comprises a step of:
scanning a relevant technological area to identify the landmark technology.

24. A system for recommending whether a current technological strategy for an organization should be modified to conform to a landmark technology, the system comprising:
a processing module examining the current technological strategy to identify any potential threats and opportunities based on the landmark technology and evaluating the identified potential threats and opportunities to develop a proposed strategy indicative of an integration of the landmark technology with the current technological strategy; and
means for determining whether any core competencies required to implement the proposed strategy should be developed internally or externally to the organization if the organization does not currently have the core competencies.

25. The system of claim 24, further comprising:
means for scanning a relevant technological area to identify the landmark technology.

26. The system of claim 24, further comprising:
means for rendering a recommendation on whether the organization should adopt the proposed strategy.

27. The system of claim 26, further comprising:
means for preparing the proposed strategy for implementation by the organization if the recommendation recommends adopting the proposed strategy.

28. The system of claim 27, wherein the preparing means requests development of the core competencies by a source internal to the organization.

29. The system of claim 27, wherein the preparing means requests development of the core competencies by a source external to the organization.

30. The system of claim 26, wherein the organization elects to adopt the proposed strategy and the system further comprises:
means for preparing the proposed strategy for implementation by the organization.
